(19) United States
(12) Patent Application Publication
(10) Pub. No.: US 2020/0398925 A1
(43) Pub. Date: Dec. 24, 2020

(54) Wormface Gear Set based Steering System for Reverse Trikes

(71) Applicant: Ravi Shankar GAUTAM, Gaya (IN)

(72) Inventor: Ravi Shankar GAUTAM, Gaya (IN)

(21) Appl. No.: 16/976,087

(22) PCT Filed: Feb. 28, 2019
(86) PCT No.: PCT/IN2019/050165

§ 371 Date: Aug. 27, 2020

(30) Foreign Application Priority Data
Feb. 28, 2018 (IN) 201821007650

(51) Int. Cl. B62K 5/08; B62K 5/05; B62K 21/02; B62K 21/12; F16H 1/20; F16H 37/04; F16H 57/039

(52) U.S. Cl. CPC B62K 5/08; B62K 5/05; B62K 21/02; F16H 2702/00; F16H 1/203; F16H 37/041; F16H 57/039; B62K 21/12

(57) ABSTRACT

This patent discloses non-tilting duplex wormface gear set based steering system for reverse trikes. Steerer rod at the center, and steerer rod controlling the wheels are connected to duplex wormface gear set each set consisting of one special worm gear two special face gear and three spur gears. Steerer rod at the center upon rotation via handle rotates coaxial worm gear which in turn rotates vertical pinion face gears engaged with it. Pinion face gear at the center then rotates transverse worm gear of the gear set of the steering system at each of the wheels via a transmission shaft which in turn rotates the horizontal pinion face gears attached to wheels, thus rotating the wheels. This steering system can also used in a four wheeler.

### FIELD OF INVENTION

Non-tilting steering system for reverse trike.

### BACKGROUND OF INVENTION

It is obvious that reverse trikes are more safe and stable than bikes and conventional trikes. Reverse trikes have many mechanical advantages over conventional trikes which include stability, traction in uphills and steerability. But providing an efficient steering mechanism for reverse trikes is a challenge. In recent past many models of reverse trikes have come up in the public domain offering tilting steering system. Tilting steering system has many issues which includes traction as well as ground clearance while cornering around a turn. Non-tilting steering system for reverse trikes have drawn little attention as it is understood by majority of folks that rack and pinion steering mechanism used in cars is sufficient for the purpose. But it has its own issues which includes big reduction ratio and too complex mechanism to handle on a trike. Non-tilting steering system is provided in Newton reverse trikes. It employs pitman arm to swing the kingpin attached to spindle mounted on each of the two front steer wheels.

### Technical Problem

Steering mechanism of reverse trike or four wheelers have externally moving parts in the form of steer transmission rods. It may be huge disadvantage in case of uneven land mass caused during snow fall.

Rotation motion is converted into translational motion which is then converted back to rotation motion

Non-tilting steering mechanism in Newton reverse trike applies the steering torque on the two wheels either from the front side of the head tube or rear side of the head tube due to which force gets exerted on the head tube rearward or forward direction respectively, thus making it difficult to operate as compared to steering system for a bicycle. In bicycles steering torque applied on the wheel is symmetric along the head tube.

### SUMMARY OF INVENTION

One of our objective is to provide steering system for reverse trike which is as ergonomic to operate as that of a bicycle.

To achieve this objective steering system for reverse trike is designed such that two front wheels can be transversely rotated using coupled torque. Steering torque is applied on each of the front wheels symmetrically on both ends of the axle and symmetrically on front and rear side of the steerer rods, thereby providing easy and stable maneuverability to the steering system. Head tube is proportional to the length of steerer rod to provide sturdiness to steerer rod.

Wheels can be turned by 360 degree.

Rotation steering action at the handle is transmitted as steering action on the wheel through rotation motion and is not converted into translational motion as intermediate phase.

It has no externally moving parts.

### BRIEF DESCRIPTION OF DRAWINGS

FIG. 1 and FIG. 2 Side and Top view respectively of reverse trike with wormface gearset based coupled torque steering system according to this invention.

FIG. 3 and FIG. 4 Back and front view respectively of wormface gearset based coupled torque steering system according to this invention.

FIG. 5 Steering mechanism according to this invention without head tubes.

FIG. 6 Central, left and right wormface gearset used as in steering mechanism according to this invention.

FIG. 7 Central, left and right wormface gearset used as in steering mechanism without head tube arms according to this invention.

FIG. 8 Blown out image of central wormface gearset

FIG. 9 Blown out image of left wheel wormface gearset

FIG. 10 Reverse trike with rotated front wheels due to steering action by steering system according to this invention.

### DESCRIPTION OF EMBODIMENTS

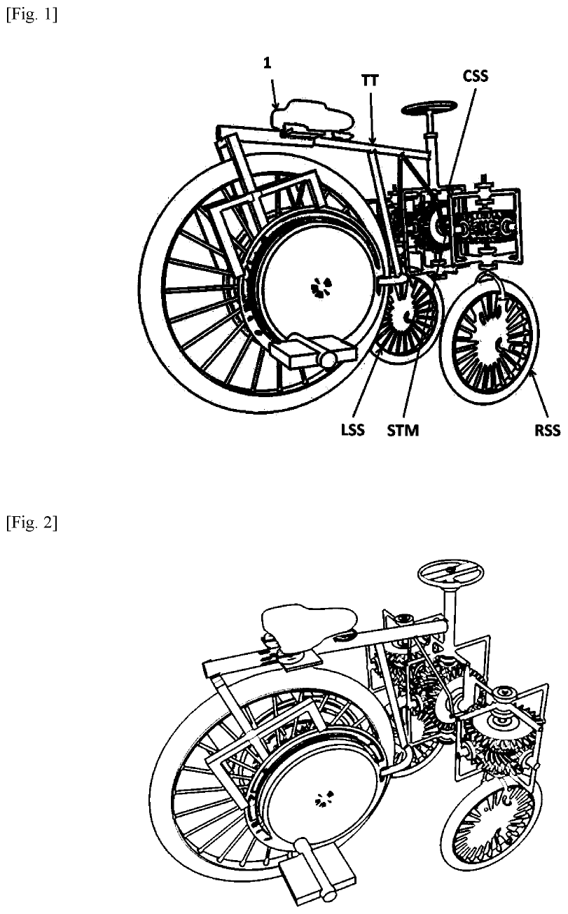

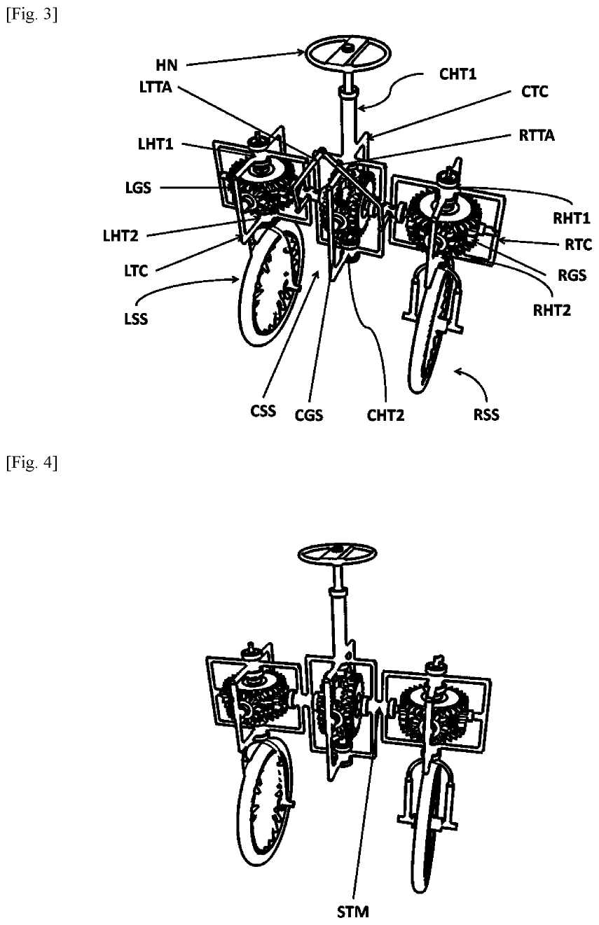

As shown in [FIG. 1] and [FIG. 3], wormface gearset based coupled torque steering system for reverse trike (1) with top tube (TT) and down tube (DT), according to this invention comprises central steering system (CSS), left wheel steering system (LSS), right wheel steering system (RSS), steer transmission mechanism (STM), steering support mechanism (SSM).

### Central Steering System

As shown in [FIG. 3] central steering system consists of central steering shaft, central head tube (CHT), central gear set (CGS) and central tubular cage (CTC).

As shown in [FIG. 3] central steering shaft (CST) is a straight shaft, connected to a handle at its top, located on the center of the front part of reverse trike.

As shown in [FIG. 3] central head tube (CHT) is a set of two sections of vertical tubes, upper section (CHT1) and lower section (CHT2) separated by distance equal to the height of central gear set with each section coaxially holding the central steering shaft using ball bearings and upper section on its rear attached to top tube (TT) and lower section attached on its rear side to down tube (DT).

As shown in [FIG. 6] and [FIG. 8] central gear set (CGS) consists of special type of coupled duplex wormface gear. It consists of spur-toothed worm gear (CWG) meshingly engaged with a pair of coaxially parallel spur-toothed face gear (CFG1) and (CFG2) which in turn is meshingly engaged with three spur gears (CSG1), (CSG1) and (CSG3).

As shown in [FIG. 3] worm gear (CWG) coaxially fixedly connected with central steerer rod (CSR) is cylindrical worm gear with a spur gear of radius greater than or equal to that of said worm gear coaxially attached at its upper end with number of worm teeth being equal to that of its spur teeth. Each of face gears (CFG1) and (CFG2) is a face gear coaxially attached at its vertically upward circular face to a spur gear of face radius greater than equal to that of said face gear with the number of face teeth being equal to the number of its spur teeth.

As shown in [FIG. 3], [FIG. 6] and [FIG. 8] face gears (CFG1) and (CFG2) are arranged and oriented such that they are coaxially parallel, face gear (CFG1) lies on the left side of worm gear, face gear (CFG2) lies on the right side of worm gear, axis of face gears (CFG1) and (CFG2) are perpendicular to that of worm gear (CWG), each face gears (CFG1) and (CFG2) are symmetrically placed with respect to worm gear, face teeth on upper half of face gears (CFG1) and (CFG2) are meshingly engaged with worm teeth of worm gear at its left and right side respectively, spur teeth of face gears (CFG1) and (CFG2) are meshingly engaged with spur teeth of worm gear (CWG) at its left and right side respectively. Face gear (CFG1) at its outward side is fixedly coaxially connected to right end of left steering arm (LSA) of steer transmission mechanism (STM). Face gear (CFG2) at its outward side is fixedly coaxially connected to left end of right steering arm (RSA) of steer transmission mechanism (STM).

As shown in [FIG. 3], [FIG. 6] and [FIG. 8] spur gears (CSG1), (CSG2) and (CSG3) are placed on front, bottom and rear point of face gears respectively such that each spur gear is equidistant from both the face gears, axis of spur gears lie on the plane perpendicular to the axis of face gears, spur teeth of spur gears are meshingly engaged with spur teeth of face gears. Bottom spur gear (CSG2) is coaxially mounted on steering shaft via ball bearing so that it is free to rotate.

As shown in [FIG. 3], central tubular cage (CTC) consists of two C-shaped rods and four L-shaped rods, surrounding central gear set, with one C-shaped rod on the front side of central gear set with its upper and lower ends connected to upper section (CHT1) and lower section (CHT2), respectively, of central head tube; one C-shaped rod on the rear side of central gear set with its upper and lower ends connected to upper section (CHT1) and lower section (CHT2), respectively, of central head tube; one L-shaped on upper right side of central gear set with its ends connected to right steer arm of steer transmission mechanism and upper section (CHT1) of central head tube; one L-shaped rod lower right side of central gear set with its ends connected to right steer arm of steer transmission mechanism and lower section (CHT2) of central head tube; one L-shaped upper left side of central gear set with its ends connected to left steer arm of steer transmission mechanism and upper section (CHT1) of central head tube; and one L-shaped rod on lower left side of central gear set with its ends connected to left steer arm of steer transmission mechanism and lower section (CHT2) of central head tube.

As shown in [FIG. 3], [FIG. 6] and [FIG. 8] pinion spur gears on front and rear side (CSG1) and (CSG3) are coaxially connected at their outer side to the rod extending from the central tubular cage via ball bearings (CBB1), (CBB2) and (CBB3) respectively.

As shown in [FIG. 3], [FIG. 6] and [FIG. 8] central face gears (CFG1) and (CFG2) are held in place by steer transmission mechanism (STM).

### Left Wheel Steering System

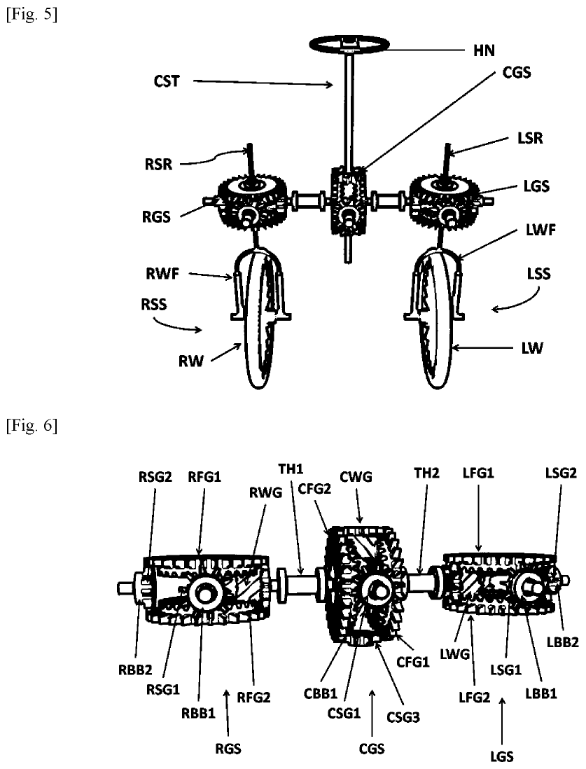

As shown in [FIG. 3] and [FIG. 5] left wheel steering system consists of a wheel (LW), left steering fork (LSF), left head tube (LHT), left gear set (LGS) and left tubular cage (LTC).

As shown in [FIG. 3] and [FIG. 5] left wheel steering fork (LSF) is a rigid/suspension fork with steerer rod (LSR) with fork blades at their ends holding the wheel (LW) at the ends of its axle.

As shown in [FIG. 3] and [FIG. 5] left head tube (LHT) is a set of two sections of vertical tubes, upper section (LHT1) and lower section (LHT2) separated by distance equal to the height of left wheel gear set (LGS) with each section coaxially holding the central steering shaft using ball bearings.

As shown in [FIG. 6] and [FIG. 9] left gear set (LGS) is structurally same as central gear set (CGS) with the difference in orientation in order to mount is mounted it on the left wheel steerer rod (LSR). Left gear set (LGS) consists of special type of coupled duplex wormface gear. It consists of spur-toothed worm gear (LWG) meshingly engaged with a pair of coaxially parallel spur-toothed face gear (LFG1) and (LFG2) which in turn is meshingly engaged with three spur gears (LSG1), (LSG1) and (LSG3).

As shown in [FIG. 6] and [FIG. 9] worm gear (LWG) is a cylindrical worm gear same as (CWG) and is coaxially fixedly connected at its spur gear face to the left end of the left steering arm (LSA) of steering transmission mechanism (STM).

As shown in [FIG. 3], FIG. 6 and [FIG. 9] each of face gear (LFG1) and (LFG2) is a face gear same as (CFG1) or (CFG2). Worm gear (LWG) and two face gears (LFG1) and (LFG2) are arranged and oriented such that worm gear (LWG) is transversely oriented and is located right side of left wheel steerer rod (LSR) with its spur face coaxially facing the central face gear (CFG1), two face gears (LFG1) and (LFG2) are coaxially parallel, face gear (LFG1) lies on the upper side of worm gear and is coaxially mounted on left wheel steerer rod (LSR) via ball bearing, face gear (LFG2) lies on the lower side of worm gear (LWG) and is coaxially fixedly connected to the left wheel steerer rod (LSR), axis of face gears (LFG1) and (LFG2) are perpendicular to that of worm gear (LWG), each face gears (LFG1) and (LFG2) are symmetrically placed with respect to worm gear, face gears (LFG1) and (LFG2) are meshingly engaged with worm gear at its upper and lower side respectively on the right side of left wheel steerer rod (LSR), spur teeth of face gears (LFG1) and (LFG2) are meshingly engaged with spur teeth of worm gear (LWG) at its upper and lower side respectively.

As shown in [FIG. 3], [FIG. 6] and [FIG. 9] spur gears (LSG1), (LSG2) and (LSG3) are placed on front, left and rear end point of face gears respectively such that each spur gear is equidistant from both the face gears (LFG1) and (LFG2), axis of spur gears lie on the plane perpendicular to the axis of face gears, spur teeth of spur gears are meshingly engaged with spur teeth of face gears (LFG1) and (LFG2).

As shown in [FIG. 1] and [FIG. 3], left tubular cage (LTC) consists of three C-shaped rods and two L-shaped rods, surrounding left wheel gear set, with one C-shaped rod on the front side of central gear set with its upper and lower ends connected to upper section (LHT1) and lower section (LHT2), respectively, of left wheel head tube; one C-shaped rod on the rear side of left wheel gear set with its upper and lower ends connected to upper section (LHT1) and lower section (LHT2), respectively, of left wheel head tube; one C-shaped rod on the left side of left wheel gear set with its upper and lower ends connected to upper section (LHT1) and lower section (LHT2), respectively, of left wheel head tube; one L-shaped on upper right side of left wheel gear set with its ends connected to right steer arm of steer transmission mechanism and upper section (LHT1) of left wheel head tube; one L-shaped rod lower right side of left wheel gear set with its ends connected to right steer arm of steer transmission mechanism and lower section (LHT2) of left wheel head tube.

As shown in [FIG. 3] pinion spur gears on front and rear side (LSG1), (LSG2) and (LSG3) are coaxially journalled at their outer side to the rod extending from the left tubular cage (LTC) via ball bearings (LBB1), (LBB2) and (LBB3) respectively.

### Right Wheel Steering System

As shown in [FIG. 3] and [FIG. 5] Right wheel steering system consists of a wheel (RW), right steering fork (RSF), right head tube (RHT), right gear set (RGS) and right tubular cage (RTC).

As shown in [FIG. 3] and [FIG. 5] right wheel steering fork (RSF) is a rigid/suspension fork with steerer rod (RSR) with fork blades at their ends holding the wheel (RW) at the ends of its axle.

As shown in [FIG. 3] and [FIG. 5] right head tube (RHT) is a set of two sections of vertical tubes, upper section (RHT1) and lower section (RHT2) separated by distance equal to the height of central gear set with each section coaxially holding the central steering shaft using ball bearings.

As shown in [FIG. 3] and [FIG. 6] right gear set (RGS) is structurally same as central gear set (CGS) with the difference in orientation in order to mount is mounted it on the right wheel steerer rod (RSR). Right gear set (RGS) consists of special type of coupled duplex wormface gear. It consists of spur-toothed worm gear (RWG) meshingly engaged with a pair of coaxially parallel spur-toothed face gear (RFG1) and (RFG2) which in turn is meshingly engaged with three spur gears (RSG1), (RSG1) and (RSG3).

As shown in [FIG. 3] and [FIG. 6] worm gear (RWG) is a cylindrical worm gear same as (CWG) and is coaxially fixedly connected at its spur gear face to the right end of the right steering arm (RSA) of steering transmission mechanism (STM).

As shown in [FIG. 3], [FIG. 6] and [FIG. 9] each of face gear (RFG1) and (RFG2) is a face gear structurally same as (CFG1) or (CFG2). Worm gear (RWG) and two face gears (RFG1) and (RFG2) are arranged and oriented such that worm gear (RWG) is transversely oriented and is located left side of right wheel steerer rod (RSR) with its spur face coaxially facing the central face gear (CFG2), two face gears (RFG1) and (RFG2) are coaxially parallel, face gear (RFG1) lies on the upper side of worm gear and is coaxially mounted on right wheel steerer rod (LSR) via ball bearing, face gear (RFG2) lies on the lower side of worm gear (RWG) and is coaxially fixedly connected to the right wheel steerer rod (RSR), axis of face gears (RFG1) and (RFG2) are perpendicular to that of worm gear (RWG), each face gears (RFG1) and (RFG2) are symmetrically placed with respect to worm gear, face gears (RFG1) and (RFG2) are meshingly engaged with worm gear at its upper and lower side respectively on the left side of right wheel steerer rod (RSR), spur teeth of face gears (RFG1) and (RFG2) are meshingly engaged with spur teeth of worm gear (RWG) at its upper and lower side respectively.

As shown in [FIG. 3] and [FIG. 6] spur gears (RSG1), (RSG2) and (RSG3) are placed on front, right and rear end point of face gears respectively such that each spur gear is equidistant from both the face gears, axis of spur gears lie on the plane perpendicular to the axis of face gears, spur teeth of spur gears are meshingly engaged with spur teeth of face gears.

Right tubular cage (RTC) consists of three C-shaped rods and two L-shaped rods, surrounding right wheel gear set, with one C-shaped rod on the front side of central gear set with its upper and lower ends connected to upper section (RHT1) and lower section (RHT2), respectively, of right wheel head tube; one C-shaped rod on the rear side of right wheel gear set with its upper and lower ends connected to upper section (RHT1) and lower section (RHT2), respectively, of right wheel head tube; one C-shaped rod on the right side of right wheel gear set with its upper and lower ends connected to upper section (RHT1) and lower section (RHT2), respectively, of right wheel head tube; one L-shaped on upper right side of right wheel gear set with its ends connected to right steer arm of steer transmission mechanism and upper section (RHT1) of right wheel head tube; one L-shaped rod lower right side of right wheel gear set with its ends connected to right steer arm of steer transmission mechanism and lower section (RHT2) of right wheel head tube.

As shown in [FIG. 3], [FIG. 5] and [FIG. 6] pinion spur gears on front and rear side (RSG1), (RSG2) and (RSG3) are coaxially journalled at their outer side to the rod extending from the right tubular cage (RTC) via ball bearings (RBB1), (RBB2) and (RBB3) respectively.

### Steer Transmission Mechanism

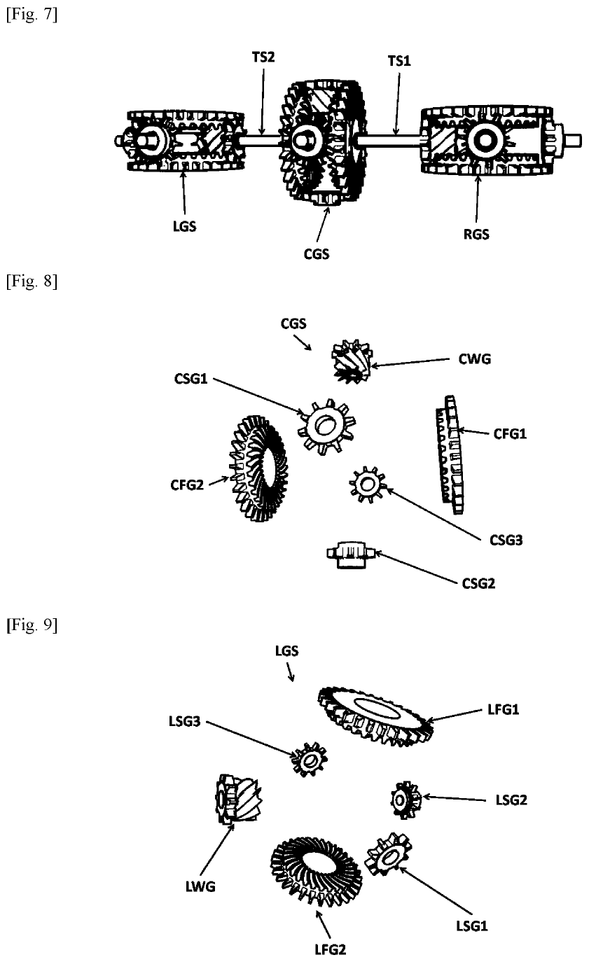

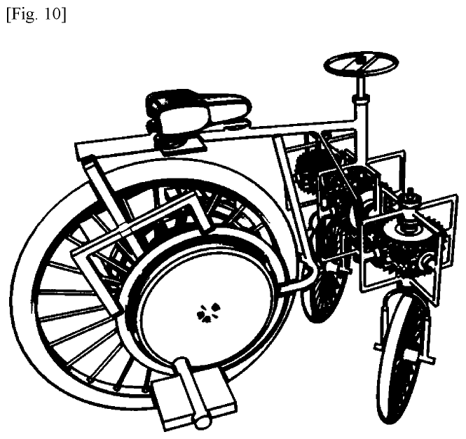

As shown in [FIG. 3], [FIG. 6] and [FIG. 7] central steering system is coupled with left wheel steering system and right wheel steering system via steer transmission mechanism (STM). Steer transmission mechanism (STM) consists of two transverse straight shafts, one transverse shaft (TS1) on right side coaxially connecting central face gear (CFG2) to right wheel worm gear (RWG) and one transverse shaft (TS2) on left side coaxially connecting central face gear (CFG1) and to left wheel worm gear (LWG) of the central gear set. Transverse shaft (TS1) and (TS2) are coaxially encased in straight tubes, right head tube arm (TH1) and left head tube arm (TH2) respectively, via ball bearings.

As shown in [FIG. 3] head tube arms on the left side and right side are connected at their rear side to top tube via rods left top tube arm (LTTA) and right top tube arm (RTTA) respectively.

### Steer Operation

On rotation in clockwise direction, handle causes worm gear (CWG) to rotate clockwise direction which in turn causes face gear causes face gears (CFG1) and (CFG2) and hence causes worm gears (LHG1) and (RHG1) to rotate clockwise direction and anticlockwise direction respectively with respect to left steer transmission arm (TS1). Rotation of worm gears (LHG1) and (RHG1) causes face gears (LFG2) and (RFG2) to rotate in clockwise direction and thus steering the wheels in clockwise direction.

Spur gears in the central gear set, left wheel gear set and right wheel gear set are auxiliary gears which help to couple the steering action of worm gears.

1. Coupled torque steering system comprising central steering system, left wheel steering system, right wheel steering system each based on wormface gear set and steer transmission mechanism.

2. Right wheel steering system and left wheel steering system claimed in [claim 1] are located on the right and left side respectively on the front part of the reverse trike with each of them comprising a wheel, steering fork, head tube, tubular cage and wormface gear set wherein
wheel is preferably of diameter less than the height of seat;
steering fork is a rigid/suspension fork with steerer rod connected at its crown and fork blades at their ends holding the wheel at the ends of its axle;
head tube consists of two vertical tubes separated by distance of wormface gear set encasing the steerer rod with the help of ball bearings;
wormface gear set consists of two coaxially parallel spur-toothed face gears, one tranverse spur-toothed worm gear, and three spur gears;
each spur-toothed face gear is a face gear with faces in the vertical direction and vertically inward face have spiral/straight tooth and vertically outward face is coaxially attached to a spur gear of radius greater than or equal to the radius of the face;
spur-toothed worm gear is a spiral/straight toothed worm gear with spur gear coaxially attached in the transversely inward face;
tubular cage consists of three C-shaped rods and two L-shaped rods which directly or indirectly holds the pinion spur gears in their designated places.

3. Wormface gear set for the wheels mentioned in [claim 2] is configured such that
upper spur-toothed face gear are coaxially mounted on the respective steerer rod with the help of ball bearings and lower spur-toothed face gear is coaxially fixedly connected to the steerer rod;
spur-toothed worm gear oriented in transverse direction lie between the spur-toothed face gear with its spur-tooth face coaxial attached to the outward end of the steer transmission arm of steer transmission mechanism, so that its spur teeth is meshingly engaged with the spur teeth of face gears;
all three spur gears are oriented so that each have its axis perpendicular to the axis of corresponding steerer rod and meshingly engaged with face gears at their periphery with one located on forward end, one on rearward end and one on transversely outward end of the face gears;
each spur gear is journalled to a horizontal rod extending from tubular cage via ball bearing.

4. Tubular cage for right wheel is configured such that
it has one C-shaped rod on front side of the right wheel wormface gear set, with their upper and lower ends attached to upper and lower sections, respectively, of the right wheel head tube and front pinion spur gear of right wheel, mentioned in [claim 3], journalled to a horizontal rod extending from its vertical middle arm via ball bearing;
it has one C-shaped rod on rear side of the right wheel wormface gear set, with their upper and lower ends attached to upper and lower sections, respectively, of the right wheel head tube and rear pinion spur gear of right wheel, mentioned in [claim 3], journalled to a horizontal rod extending from its vertical middle arm via ball bearing;
it has one C-shaped rod on right side of the right wheel wormface gear set, with their upper and lower ends attached to upper and lower sections, respectively, of the right wheel head tube and right pinion spur gear of right wheel, mentioned in [claim 3], journalled to a horizontal rod extending from its vertical middle arm via ball bearing;
one L-shaped rod on the left upper side of the steerer rod with its end attached to right arm of steer transmission mechanism mentioned in [claim 1] and upper section of head tube;
one L-shaped rod on the left lower side of the steerer rod with its end attached to right arm of steer transmission mechanism mentioned in [claim 1] and lower section of head tube.

5. Tubular cage for the left wheel are configured such that
it has one C-shaped rod on front side of the left wheel wormface gear set, with their upper and lower ends attached to upper and lower sections, respectively, of the left wheel head tube and front pinion spur gear of left wheel, mentioned in [claim 3], journalled to a horizontal rod extending from its vertical middle arm via ball bearing;
it has one C-shaped rod on rear side of the left wheel wormface gear set, with their upper and lower ends attached to upper and lower sections, respectively, of the left wheel head tube and rear pinion spur gear of left wheel, mentioned in [claim 3], journalled to a horizontal rod extending from its vertical middle arm via ball bearing;
it has one C-shaped rod on left side of the left wheel wormface gear set, with their upper and lower ends attached to upper and lower sections, respectively, of the left wheel head tube and left pinion spur gear of left wheel, mentioned in [claim 3], journalled to a horizontal rod extending from its vertical middle arm via ball bearing;
one L-shaped rod on the right upper side of the steerer rod with its ends attached to left steer arm of steer transmission mechanism mentioned in [claim 1] and upper section of head tube;
one L-shaped rod on the right lower side of the steerer rod with its ends attached to left steer arm of steer transmission mechanism mentioned in [claim 1] and lower section of head tube.

6. Central steering system claimed in [claim 1] located on centre of the front part of the reverse trike, comprises, central steering shaft, central head tube, central tubular cage and central wormface gear set wherein
central steering shaft is a straight shaft with handle at its top;
central head tube consists of two vertical tubes as upper section and lower section separated by distance of central wormface gear set encasing the central steering shaft with the help of ball bearings with upper section connected at its rear side to the top tube of the reverse trike and lower section at its rear side is connected to the down tube of the reverse trike;
central wormface gear set consists of two coaxially parallel spur-toothed face gears with faces in transverse direction, one vertical spur-toothed worm gear with spur tooth at its upper end, and three spur gears;
spur-toothed face gear is a face gear with face along transverse direction and transversely inward face have spiral/straight tooth and spur gear coaxially attached in the transversely outward face;
spur-toothed worm gear is a spiral/straight toothed worm gear coaxially attached at its upper face to a spur gear;
central tubular cage consists of two C-shaped rods and four L-shaped rods which directly or indirectly holds the pinion spur gears in their designated places.

7. Central wormface gear set mentioned in [claim 2] is configured such that
left spur-toothed face gear are coaxially attached at its left face to the right end left steer arm of steer transmission mechanism and right spur-toothed face gear are coaxially attached at its right face to the left end of the left steer arm of steer transmission mechanism;
spur-toothed worm gear vertical direction lie between the spur-toothed face gear with its spur-tooth face on the upper side coaxial attached to the central steerer rod, so that its spur teeth is meshingly engaged with the spur teeth of face gears;
all three spur gears are oriented so that each have its axis perpendicular to the axis of central steerer rod and meshingly engaged with face gears at their periphery with one located on forward end, one on rearward end and one on downward end of the face gears;
each spur gear is journalled to a horizontal rod extending from central tubular cage via ball bearing;

8. Central tubular cage is configured such that
it has one C-shaped rod on front side of the central wormface gear set, with their upper and lower ends attached to upper and lower sections, respectively, of the central head tube and front pinion spur gear, mentioned in [claim 7], journalled to a horizontal rod extending from its vertical middle arm via ball bearing;
it has one C-shaped rod on rear side of the central wormface gear set, with their upper and lower ends attached to upper and lower sections, respectively, of the central head tube and rear pinion spur gear, mentioned in [claim 7], journalled to a horizontal rod extending from its vertical middle arm via ball bearing;
one L-shaped rod on the left upper side of the central gear set with its end attached to left steer arm of steer transmission mechanism mentioned in [claim 1] and upper section of central head tube;
one L-shaped rod on the left lower side of the central gear set with its end attached to left steer arm of steer transmission mechanism mentioned in [claim 1] and lower section of central head tube;
one L-shaped rod on the right upper side of the central gear set with its end attached to right steer arm of steer transmission mechanism mentioned in [claim 1] and upper section of central head tube and
one L-shaped rod on the right lower side of the central gear set with its end attached to right steer arm of steer transmission mechanism mentioned in [claim 1] and lower section of central head tube.

9. Central steering system is coupled with left wheel steering system and right wheel steering system via steer transmission mechanism mentioned in [claim 1].

10. Steer transmission mechanism mentioned in [claim 1] and [8] consists of two transverse straight shafts, one on right side of central gear set coaxially connecting right central bevel pinion gear to the left pinion spur gear of right wheel, one on left side of central gear set coaxially connecting left bevel pinion gear to the right pinion spur gear of left wheel, with each transmission shaft encased in head tube arms via ball bearings wherein
head tube arms on the left side and right side are connected at their rear side to top tube via appropriately bent rods.

11. Handle claimed in [claim 2] is preferably round wheel handle with its stem connected to the upper end of central steering shaft claimed in [claim 3], is located above the front end of the top tube of reverse trike at a height around the height of seat.
